(19) United States
(12) Patent Application Publication
(10) Pub. No.: US 2007/0256658 A1
(43) Pub. Date: Nov. 8, 2007

(54) COMBINED VARIABLE COMPRESSION RATIO AND PASSIVE IGNITION SYSTEM

(76) Inventors: Per Gosta Edvin Andersson, Downers Grove, IL (US); James William Brogdon, Daphne, AL (US)

Correspondence Address: Thomas Moga;Butzel Long, STONERIDGE WEST, 41000 WOODWARD AVENUE, BLOOMFIELD HILLS, MI, 48304, US

(21) Appl. No.: 11/682,759

(22) Filed: Mar. 6, 2007

Related U.S. Application Data
(60) Provisional application No. 60/779,606, filed on Mar. 6, 2006.

(51) Int. Cl. F02F 1/24

(52) U.S. Cl. 123/193.5

(57) ABSTRACT

An arrangement for a reciprocating internal combustion engines is provide that includes a reciprocating main piston and a smaller cell piston which works in cooperation with the main piston to vary the compression ratio of and igniting a fuel-air mixture in a homogenous compression ignition engine. An actuator controls movement of the smaller cell piston relative to movement of the main piston.

### TECHNICAL FIELD

The embodiment of the disclosed invention relates generally to reciprocating internal combustion engines. More particularly the present invention relates to an engine having a reciprocating main piston and a smaller cell piston which works in cooperation with the main piston to vary the compression ratio of and igniting a fuel-air mixture in a homogenous compression ignition engine.

### BACKGROUND OF THE INVENTION

Many forms of non-spark ignition systems are know for use in internal combustion engines. One of the oldest arrangements is the hot bulb ignition typically used with fuels such as crude oil, vegetable oil, and diesel fuel. An external heat source such as a flame is used to heat a protrusion on the engine head known as a bulb. Once the bulb is hot enough, the engine can be started by turning the flywheel. The compression of the air-fuel mixture and the heat in the bulb caused the fuel to ignite and, once working, the bulb would stay hot enough to keep the engine running.

Another ignition system (the so-called “SmartPlug” system) consists of a pre-chamber containing a catalytic heating element. In this system cold starting requires up to 25 watts per igniter from an external power supply. Once the engine is warmed up under moderate load, the power supply is not required and the system is self-sustaining under load.

In diesel systems, the fuel injection nozzle creates some turbulence as the fuel is injected into the combustion space. However, the so-called “Lanova” air or energy cell can be used to create the turbulence necessary for proper mixing of the fuel and compressed air in the cylinder of a diesel engine to obtain efficient combustion. A Lanova cell is an auxiliary chamber located in the cylinder head of a divided chamber type. The cell has two rounded spaces that are cast into the cylinder head opposite the fuel injector across the narrow section where the intake and exhaust valve lobes of the main combustion chamber join. Typically the cell volume is less than 20% of the main chamber volume.

During the compression stroke, the piston forces air into the energy cell. Near the end of the stroke the nozzle sprays fuel across the main chamber where between a third and a half mixes with the hot air and burns at once. The remainder of the fuel enters the energy cell and starts to burn there. The pressure in the cell rises sharply, causing the combustion products to flow at a high velocity into the main combustion chamber and setting up a swirling movement of fuel and air in the lobes. This promotes final fuel-air mixing and ensures complete combustion. The restricted openings between the two cell spaces and the cell and the main chamber control the time and rate of expulsion of the turbulence-creating blast from the energy cell.

In the Sonex® piston arrangement cavities called “micro-chambers” are formed around the circumference of the piston bowl. The micro-chambers form a segmented ring with each chamber positioned in line with a fuel injector spray. The micro-chambers are connected to the piston bowl by tunnel-like vents arranged so that a small fraction of the fuel can be trapped in the micro-chambers. The flame from the main chamber is quenched by the vent preventing complete combustion in the micro-chambers. Slow and incomplete combustion in the micro-chambers forms highly reactive radicals and intermediate species that exit at high velocity to reduce emissions in standard diesel engines.

A variable compression ratio (“VCR”) piston typically involves variation in the compression height. A VCR piston requires a means to activate the height variation within a high speed reciprocating assembly. One method is to use hydraulics supplied from the engine lubricating oil to raise and lower an outer piston relative to an inner piston, but reliable control of the necessary oil flow is a problem. In some arrangements a Belville washer has been provided to spring the piston crown upwards against the combustion forces. This is intended to reduce the peak firing loads so that compression ratio variation becomes self-acting rather than externally controlled.

While these modifications represent general improvements in the state of the art of engine systems providing variable compression ratios, there yet remains room for improvements in this technology.

### SUMMARY OF THE INVENTION

The present invention overcomes several problems known in the prior art and provides an advancement in internal combustion engine technology. The present invention provides an internal combustion engine having a cylinder block and a cylinder head. A cell cylinder is formed in the cylinder head. A cell piston is reciprocatingly provided in the cell cylinder. The cell piston is driven by an actuator. A main cylinder is formed in the cylinder block. A main piston is reciprocatingly provided in the main cylinder. A pepperpot having one or more orifices is formed between the cell cylinder and the main cylinder. The pepperpot is insulated from the surrounding cylinder head by an insulating material.

The cell cylinder and the cell piston are provided to vary the volume of the cylinder and therefore the compression ratio of the complete cylinder system.

The cell piston is movable between an intake position in which gas is drawn into the cell cylinder through the orifice(s) and a compression position in which gas is forced out of the cell cylinder through the orifice(s). The cell piston is moved to its intake position while the main piston is moving toward its top dead center position. Once the main piston achieves top dead center, the cell piston is moved to its compression position and the gas previously drawn into the cell cylinder is driven out and into the main cylinder. Once compression is effected, the cell piston remains generally in its compression position while the main piston is moved away from the pepperpot on its power stroke.

The present invention provides the very precise feedback and quick response times absent from the prior art. The present invention provides for a rapid increase in compression pressure and temperature for more positive ignition.

Other features of the various embodiments of the invention will become apparent when viewed in light of the detailed description of the preferred embodiments when taken in conjunction with the attached drawings and the appended claims.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 illustrates a fragmentary, schematic cross-sectional view of an engine provided with the variable compression ratio of the present invention showing the main piston moving toward compression and the small piston moving to allow the gas to move into the air cell;

FIG. 2 is a view similar to that of FIG. 1 but showing the main piston at top dead center and the small piston moving toward the main piston to compress the charge in the main cylinder; and

FIG. 3 is a view similar to that of FIG. 3 but showing the main piston moving away from top dead center after ignition.

### DETAILED DESCRIPTION OF THE PREFERRED EMBODIMENT

In the following figures, the same reference numerals will be used to refer to the same components. In the following description, various operating parameters and components are described for plural constructed embodiments. These specific parameters and components are included as examples and are not meant to be limiting.

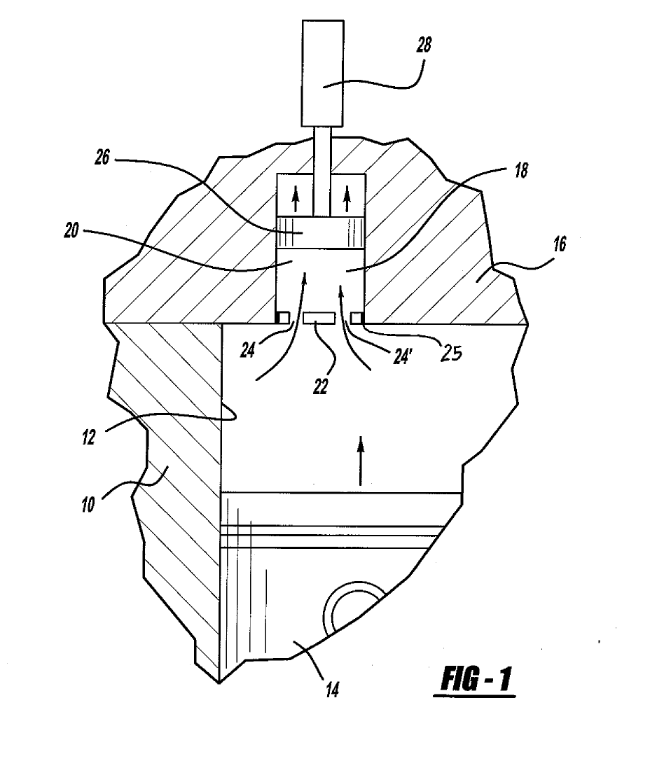

With reference to FIG. 1, an engine block 10 is illustrated. The configuration of the engine block 10 is shown only for illustrative purposes and is not intended as being limiting. The engine block 10 may find utility in any one of a variety of applications, including automotive vehicles and trucks.

The engine block 10 has a main cylinder 12 formed therein. A main piston 14 is reciprocatingly provided in the main cylinder 12 in a known manner. The open upper end of the main cylinder 12 is closed by a cylinder head 16. Conventional engine elements such as intake valves, exhaust valves, a connecting rod and a crankshaft are not illustrated as these components, their arrangement and configurations, are well known to those skilled in the art.

An air cell 18 is formed in the cylinder head 16. It is to be noted that while the air cell 18 is shown as being formed in the cylinder head 16, it may be that the air cell 18 may be alternatively formed in the cylinder block or in the piston. However, in the illustrated embodiment which is intended as being non-limiting the air cell 18 is formed in the cylinder head 16 and is defined by a cell cylinder 20. A multi-holed pepperpot 22 is formed at the lower end of the cell cylinder 20. The pepperpot 22 includes at least one orifice and may include two or more orifices, as illustrated in the figures as a pair of orifices 24, 24′ although it is to be understood that the configuration of the pepperpot 22 is based on appropriately tailored thermal conductivity. An insulating material 25 is provided between the pepperpot 22 and the wall of the cell cylinder 20.

The air cell 18 further includes a reciprocating cell piston 26. Movement of the cell piston 26 between a first or raised position and a second or lowered position varies the volume of the cell cylinder 20 and therefore the compression ratio of the cell cylinder 20 and the main cylinder 12. An actuator 28 of a known design is provided to selectively move the reciprocating cell piston 26 between the first or raised position and the second or lowered position. The actuator 28 may be part of a mechanical system, such as a camshaft, or may be an electronic or hydraulic system. As a further alternative arrangement a crank-driven piston may be provided having a variable phase angle to allow control over the compression ratio.

In operation, and referring to FIG. 1, as the main piston 14 moves toward the top of the main cylinder 12, the cell piston 26 moves away from the pepperpot 22 and gas is drawn into the cell cylinder 20. The effective compression ratio of the combination is lower than that of just the main cylinder 12 and the main piston 14 assembly. This lower compression ratio avoids ignition of the homogenous charge on the upward stroke of the main piston 14.

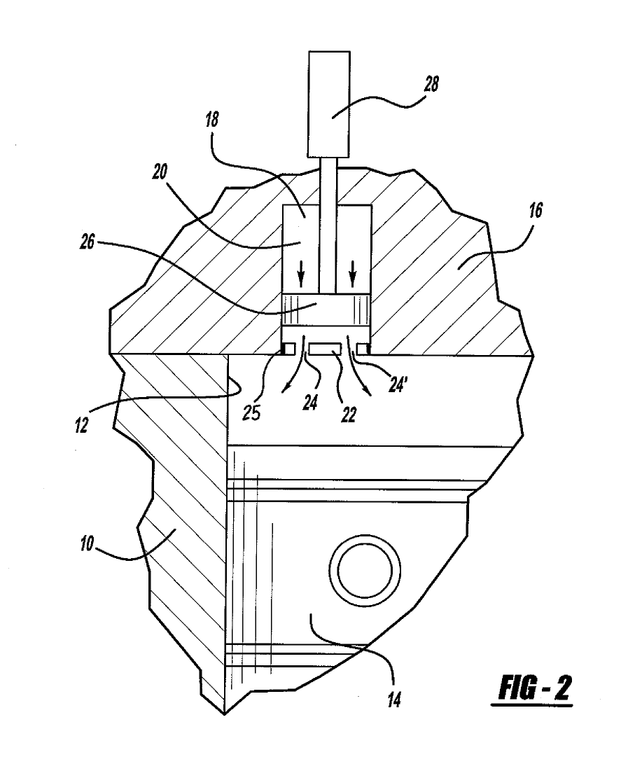

Referring to FIG. 2, the main piston 14 has moved to a point around top dead center (“TDC”). At or about this point the actuator 28 drives the cell piston 26 toward the pepperpot 22 thus compressing the charge in the cell cylinder 20. This forces the hot gas (or the air-fuel mixture) out of the cell cylinder 20 through the orifices 24, 24′ and into the main cylinder chamber 12. The hot gas exiting the cell cylinder 26 through the orifices 24, 24′ formed in the pepperpot 22 provides a higher pressure and temperature in the main cylinder 12 that will ignite the homogeneous charge in the main cylinder 12, provided that the main charge is rich enough for ignition.

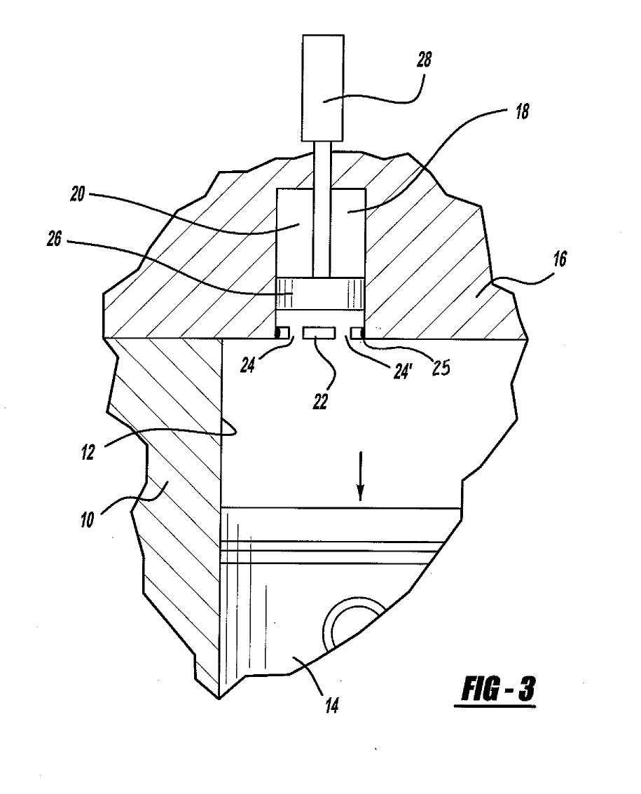

With the cell piston 26 in its compression position as illustrated in FIG. 2, ignition occurs and the main piston 14 is driven in a direction away from the pepperpot 22 as illustrated in FIG. 3. The cell piston 26 remains generally in this position until the powerstroke of the main piston 14 is completed and the main piston 14 begins its movement again toward the pepperpot 22, whereupon the cell piston 26 again begins to move as shown in FIG. 1.

It should be understood that for certain operating conditions the cell piston 26 may be maintained in a fixed position and the pepperpot 22 may, on its own, provide ignition to the charge. With the cell piston 26 in a fixed position, the gas in the main cylinder 12 will enter the cell cylinder 20 on the upstroke of the main piston 14 and will exist the cell cylinder 20 on the downstroke of the main piston 14. The charge will be heated on both entry and exit to the cell cylinder 20 and will provide an ignition function on exiting the cell cylinder.

Advantages over existing technology are that controlling the ignition point of the homogeneous charge and high load operation is difficult with today's indirect methods of adjusting cylinder pressure via variable valve timing or inlet manifold temperature. These methods require very precise feedback and quick response times that are difficult to achieve. The proposed device according to the present invention provides for a rapid increase in compression pressure and temperature for more positive ignition.

The foregoing discussion discloses and describes exemplary embodiments of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. An arrangement for an internal combustion engine comprising:
an engine component having a cell cylinder formed therein;
a cell piston reciprocatingly provided in said cell cylinder;
an actuator operatively associated with said cell piston;
a main cylinder formed in the engine;
a main piston reciprocatingly provided in said main cylinder; and
at least one orifice formed between said cell cylinder and said main cylinder through which a selective volume of gas may be passed.

2. The arrangement of claim 1 wherein said engine component is a cylinder head.

3. The arrangement of claim 1 wherein said actuator is selected from the group consisting of a mechanical actuator, an electronic actuator, and a hydraulic actuator.

4. The arrangement of claim 1 wherein said pepperpot has a thermal conductivity selected to provide appropriate thermal energy to the charge air passing through said at least one orifice.

5. The arrangement of claim 1 further including a pepperpot formed between said cell cylinder and said main cylinder, said at least one orifice being formed in said pepperpot.

6. The arrangement of claim 1 wherein said cell piston is movable between a compression position in which gas is driven out of said cell cylinder through said at least one orifice and an intake position in which gas is drawn into said cell cylinder through said at least one orifice.

7. The arrangement of claim 6 in which said main piston and said cell piston move in the same direction upon intake of gas into said cell cylinder.

8. The arrangement of claim 7 wherein said main piston can be moved to a top dead center position and in which said cell piston moves to said compression position when said main piston is substantially in said top dead center position.

9. An arrangement for an internal combustion engine comprising:
a cell cylinder formed in the engine, said cell cylinder having a cell piston provided therein, said cell piston being movable between an intake position and a compression position;
a main cylinder formed in the engine, said main cylinder having a main piston provided therein, said main piston being movable between a first position and a second position, said second position;
an insulated pepperpot formed between said cell piston and said main piston, said pepperpot having at least one orifice formed therein,
whereby said cell piston is movable to control the compression ratio of the gas in said cell cylinder and said main cylinder.

10. The arrangement of claim 9 wherein the engine includes a cylinder head and wherein said cell cylinder is formed in said cylinder head.

11. The arrangement of claim 9 further including an actuator to selectively drive said cell piston.

12. The arrangement of claim 11 wherein said actuator is selected from the group consisting of a mechanical actuator, an electronic actuator, and a hydraulic actuator.

13. The arrangement of claim 9 wherein said pepperpot has a thermal conductivity selected to provide appropriate thermal energy to the charge air passing through said at least one orifice.

14. The arrangement of claim 9 wherein gas is driven through said at least one orifice of said pepperpot when said cell piston is moved to said compression position and said gas is driven through said at least one orifice of said pepperpot when said cell piston is moved to said intake position.

15. The arrangement of claim 14 in which said main piston and said cell piston move in the same direction upon intake of gas into said cell cylinder.

16. The arrangement of claim 15 wherein said main piston can be moved to a top dead center position and in which said cell piston moves to said compression position when said main piston is substantially in said top dead center position.

17. A method for varying the compression ratio of a cylinder chamber in an internal combustion engine, the method comprising the steps of
forming an internal combustion engine having an engine component having a cell cylinder formed therein, a cell piston reciprocatingly provided in said cell cylinder, an actuator operatively associated with said cell piston, a main cylinder formed in the engine, a main piston reciprocatingly provided in said main cylinder, and at least one orifice formed between said cell cylinder and said main cylinder through which a select volume of gas may be passed;
moving said cell piston generally away from said at least one orifice while moving said main piston generally toward said at least one orifice until said main piston reaches a position of top dead center;
moving said cell piston toward said orifice;
igniting said select volume of gas; and
moving said main piston away from said orifice.

18. The method of claim 17 further including a pepperpot positioned substantially between said cell cylinder and said main cylinder;

19. The method of claim 18 further including an insulating material positioned between said pepperpot and said cell cylinder.

20. The method of claim 19 wherein said pepperpot has a thermal conductivity selected to provide appropriate thermal energy to the charge air passing through said at least one orifice.
